(19) United States
(12) Patent Application Publication
(10) Pub. No.: US 2006/0121243 A1
(43) Pub. Date: Jun. 8, 2006

(54) Surface bonding method for PET film and silica gel buttons and a manufactured article of the same

(75) Inventors: Yao-Ling Chen, Taipei Hsien (TW); Ming-Chung Tien, Taipei Hsien (TW); Li-Chung Han, Hsintien City (TW); Ruo-Na Wang, Zhang Jiakou City (TW)

Correspondence Address: BIRCH STEWART KOLASCH & BIRCH, PO BOX 747, FALLS CHURCH, VA, 22040-0747, US

(73) Assignee: SILITECH TECHNOLOGY CORP.

(21) Appl. No.: 11/003,512

(22) Filed: Dec. 6, 2004

(51) Int. Cl. B32B 3/10

(52) U.S. Cl. 428/138

(57) ABSTRACT

A surface bonding method for bonding a PET film and silica gel buttons is provided which can shorten the manufacturing period, reduce the required number of fixtures and improve production efficiency. The surface bonding method comprises the following steps: providing a PET film and performing surface treatment on the PET film, coating a layer of UV glue on the PET film, providing a plurality of silica gel buttons, performing surface treatment on the bottom surfaces of the silica gel buttons, placing the silica gel buttons into the bonding fixture, placing and fixing the PET film to the bonding fixture, stitching a transparent plate onto the PET film, and applying the exposure of UV-light on the bonding fixture.

### BACKGROUND OF THE INVENTION

1. Field of the Invention

This invention refers to a surface bonding method for a PET film and a silica gel button and an article thereof, and more particularly to a surface bonding method for bonding the outer bottom surface of a silica gel button and a PET film and an article thereof, such as which can be used in the keyboard of a desktop computer or a notebook computer, the keypad of a mobile phone or a handset speakerphone for wireless communication, etc.

2. Description of the Prior Art

Polyethylene terephthalate, (PET for short) has inherently good transparency and glossiness, is weather resistant,is antifatigueand heat tolerant, has good electrical character, is wear resistant and easily recycled. As such it is increasingly and widely used in mechanical and electrical fields. However, PET material is a crystalline plastic so the molecular alignment is compact and ordered. Consequently it has a stable molecular structure and low surface free energy. These kinds of materials are always difficult to bond.

Silica gel is a polymer with small surface tension, and is also difficult to bond due to its low free energy surface. It is certainly difficult to bond PET and silica gel materials together. Thus it is not easy to find a new bonding method to securely bond PET film and silica gel buttons and achieve the goal of mass production for their related products.

In the prior art, similar products are manufactured by a process of binding PET film and silica gel buttons with an oven-dried bonding agent. This is done by coating a PET film with a bonding agent, and then using a bonding fixture to join the PET film and the silica gel buttons together by pressure. The multiple sets of jointed products and fixtures are then placed into an oven for drying. The baking process needs to last for at least 30 minutes under a predetermined temperature. After the baking process, the temperature of the fixture must be allowed to cool naturally before the fixture can be opened to obtain the bonded products.

However, the above-mentioned bonding method not only needs a large number of fixtures, but also the bonding period for each set of fixtures requires at least 40 to 50 minutes. Thereby the method is not competitive in terms of cost and is a time consuimg process. Additionally, the adhesive force of the bonded product often does not reach the requirements of customers (the pulling force should be larger than or equal to 1 Kg), resulting in a low yield.

### SUMMARY OF THE INVENTION

The main object of this invention is to provide a surface bonding method for bonding PET film and silica gel buttons, thereby shortening the manufacturing period, reducing the required number of fixtures and improving production efficiency.

Another object of this invention is to provide an article produced by the surface bonding method for bonding PET film and silica gel buttons, wherein the adhesive force between the PET film and the silica gel buttons is increased.

In order to achieve the above-mentioned objectives, the surface bonding method according to this invention is comprised of the following steps: providing a bonding fixture, where the bonding fixture is provided with a plurality of holes and more than two position setting poles; providing a PET film and performing surface treatment on the PET film; coating a layer of UV glue on the PET film; providing a plurality of silica gel buttons; performing surface treatment on the bottom surfaces of the silica gel buttons; placing the silica gel buttons into the holes of the bonding fixture; placing and fixing the PET film to the bonding fixture; stitching a transparent plate onto the PET film, wherein the transparent plate is provided with position setting holes corresponding to the position setting poles such that the transparent plate is fixed; and applying the exposure of UV-light on the bonding fixture.uiui

In order to achieve the above-mentioned and other objectives, the manufactured article of PET film and silica gel buttons according to this invention is produced by the previously-mentioned surface bonding method, wherein comprising a PET film with a surface which is surface-treated; a layer of UV glue coated on the surface of the PET film; and a plurality of silica gel buttons which are bonded with a layer of UV glue to the surface of the PET film by means of a fixture.

In the following the invention will be described in greater detail in connection with preferred embodiments and with reference to the accompanying drawings, but the description is merely for illustrative purposes, without any limitation to the scope of the present.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is an exploded view of a PET film, silica gel buttons and a fixture according to the invention;

FIG. 2 is an assembly view of the PET film, silica gel buttons and fixture according to the invention;

FIG. 3 is a relationship graph between the adhesive forces of the PET film and the bonding agents;

FIG. 4 is a flow chart illustrating the surface bonding method for PET film and silica gel buttons according to the invention.

### DETAILED DESCRIPTION OF THE EMBODIMENTS

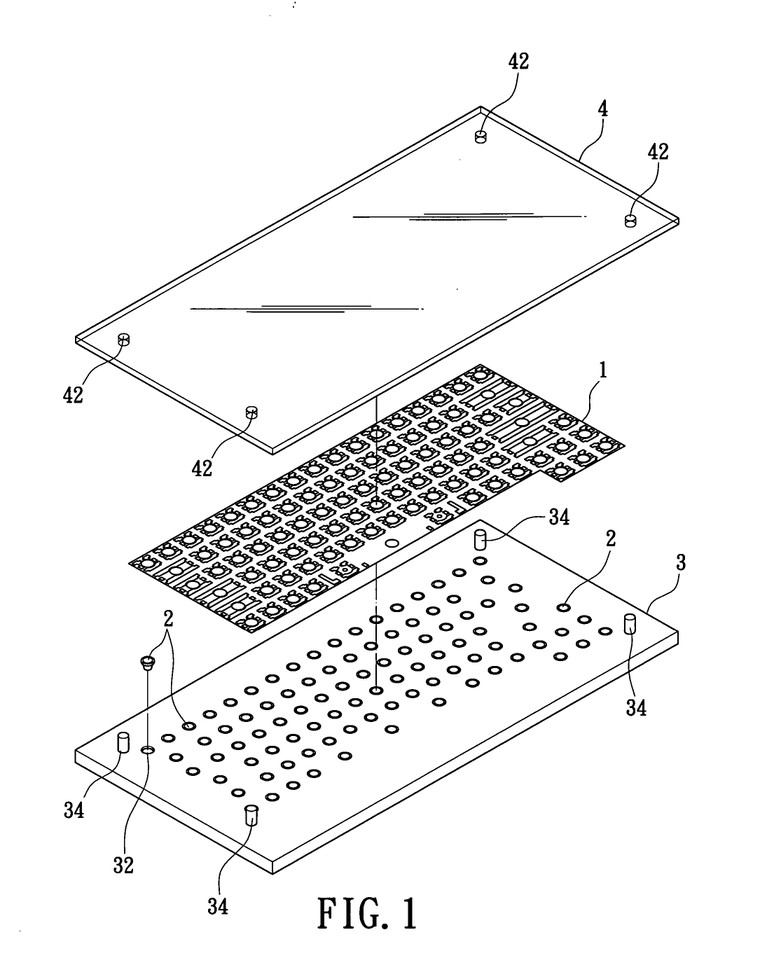

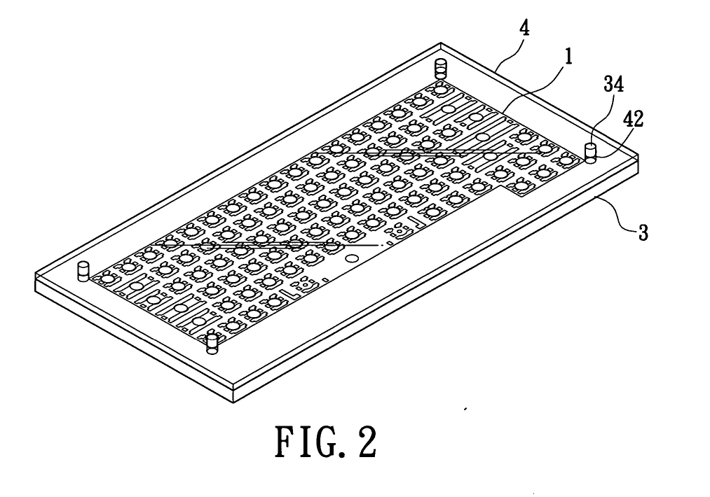

Referring to FIGS. 1 and 2, the exploded and assembly views of a PET film, silica gel buttons and a fixture are shown. The method according to this invention is first to perform surface treatment on a PET film 1 and silica gel buttons 2. Since a metal surface has large surface tension and is a high energy surface which is easily bonded, and plastic and rubber surfaces have small surface tension and are low energy surfaces which are difficult to bond, surface treatment must first be performed on the PET film 1 and the silica gel buttons 2 to increase the surface adhesive force.

The surface property of a polymer material is related to its chemical structure and crystallinity. Even if the molecular structure is the same, the surfaces of polymer material with different crystallinity are significantly different. Therefore, surface treatment needs to be performed on the surface of the PET film 1 and the silica gel buttons 2 to change their chemical properties before bonding, thereby increasing the adhesive force of the coating layer.

The surface treatment for a polymer material includes four approaches:

1. Clearing up weak boundary layer (WBL): such methods as using a solvent or surface active agent or brine treatment are used to clear up the weak boundary layer of the plastic and rubber surfaces, for example, various assistants drifting from the inside of the products to the surface or absorbtion of dust and grime and so on.

2. Increasing the bonding force of the boundary layer: in principle, a chemical bond is the strongest bonding possible between substances, followed by a hydrogen bond. An interaction force between molecules is the weakest. In order to increase the bonding force between the boundary layers, the most effective method is to improve the chemical bond between the coating layer and the substrate. With the surface treatment, the functional group is generated on the surface of the substrate, such that a chemical reaction occurs between it and the film forming matter on the coating material, or bonding in hydrogen bond form, so that a hydroxyl group (—OH) or carbonyl group (—CO—) is formed.

3. Making the surface of the substrate rough: enlarging the contact area of the substrate surface and the coating layer is one of the approaches for increasing adhesive force. Of course, increasing roughness must work together with good wetting action of the coating material on the substrate.

4. Inter-dissolving between the substrate and the coating material: an appropriate solvent and a substrate material and a film forming matter with approximate dissolvatility parameters are chosen to ensure that a consolute effect occurs to the high-molecules of the substrate material and the film forming matter. They are then mixed to form a strong bond between them. It is noted that the situation of over-solvent and swelling should be avoided.

There may be many surface treatment methods, such as treatment by dissolvent, by resin acceptor, flame treating, UV exposure, plasma surface and so on. During the selection of a surface treatment method, the physico-chemical characteristics of the materials to be treated should be taken into consideration, as well as the practical production situation, in order to satisfy the requirement of high efficiency, low cost and easy of operation.

This invention is to treat a PET film without printed conductive metal by corona discharge method which is one of the methods of plasma surface treatment. Particularly, the PET film 1 is conveyed to the corona treating device and surface treatment is performed by discharging the electrical spark onto the PET film 1 from the discharge electrode. After corona treating, some oxidative, degradation and polymerization actions occur to the high-molecular polymer on the surface of the treated PET film 1. The functional groups of large polarity, such as hydroxyl group, carbonyl group, etc. are introduced to the molecular chain of the PET, thereby making it possible to generate a chemical bond by reaction with the glue. In addition, the surface of the PET film 1 treated by corona treating method can increase the roughness, so as to enlarge the contact area with the glue and facilitating an increase in the adhesive force.

With the consideration of various surface treatment methods according to the embodiments of this invention, the method of treating PET film by corona treating is preferred, for the reason that treating the surface of PET film by corona treating method is quick and efficient and has a long lasting effectIt only takes ten seconds to achieve the best effect. The surface tension of the treated PET film can reach more than 40 (mN/sq.m.) from less than 30 (mN/sq.m.) after treatment, following the spreading and wetting of the glue on the surface. In comparison with the chemical treatment method, the corona treating method has the advantages of a long period of effectiveness, its is both safe and non-toxic, and is compatibile with the requirements of environmental protection laws.

According to this invention, the corona treating method is also applied on the silica gel buttons 2 which are not disposed with conductive particles. Particularly, the silica gel buttons 2 are positioned upside down on an insulted platform, such that the ring substrate of its bottom is oriented upwards and the bottom surface to be bonded also faces upwards. Then the insulted platform is conveyed to the corona treating device for corona treatment.

The corona treating method is not applicable to the PET film 1 with metal circuit printed on its surface or silica gel buttons 2 disposed with conductive particles. The reason for this is that metal materials or conductive particles are capable of electrical conduction. So contact with an electrical spark may result in the burning of the PET material. Considering this, the method according to this invention is to irradiate the surface of the PET film 1 by using an UV light where the product surface is spaced away from the light source at 15 cm for approximate 3 minutes. After UV-exposure treatment, the surface roughness of the treated PET film significantly changes and oxygenic functional groups are generated, the surface crystallinity degrades somewhat. The UV-exposure treatment on the PET film should use less than 250 nm short wavelength UV light. The longer the UV light's wavelength, the weaker the effect of the treatment. Similarly, the UV exposure treatment method can also be used for silica gel buttons with conductive particles.

A glue is required to bond the treated PET film 1 and silica gel buttons 2. With respect to which kind of glue is preferrable, the bonding force between the silica gel button 2 and the PET film 1 is an important indicator by which costumers evaluate the bonded products. Therefore the choice of glue is key to achieving a firm bond.

A good adhesive result satisfies the following requirements:

1. The bonding agent fully wets the substrate.

2. The polarity of the bonding agent is similar to that of the substrate (approximate in dissolvatility parameter).

3. The substrate is cleaned up in advance to fully remove the weak boundary layer on its surface.

4. Surface active treatment is temporarily applied on the substrate.

5. The entire process is optimized according to the practical application.

There are several types of glue used in this field: oven-drying glue, instant glue and UV glue. Instant glue solidifies too quickly and can not used for printing. It is thus not applicable to the process, even if it provides a good adhesive strength for bonding the PET film and silica gel buttons. If an oven-drying glue is used for the bonding, a large number of bonding fixtures are required. Since oven-drying time takes a long time(generally 30 minutes required), the intervals between using the fixtures are long. This results in high cost and affects the yield. The development of the manufacturing process for UV glue solves the above-mentioned contradiction in practical applications.

For UV glue, some factors must be taken into consideration. Particularly, the surface tension of the treated PET film can reach more than 40 (mN/sq.m.), thereby the glue needs to be less than the value, so as to fulfill spreading and wetting of the glue.

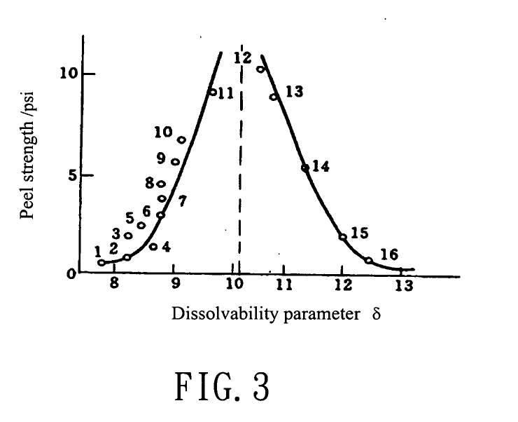

In addition, the dissolvatility parameter of the agent is a very important physical indicator for the adhesion of the coating material on the rubber substrate. Only if there is a good consolute condition of high-molecular substrate and coating resin, can a good adhesion be obtained. Referring to FIG. 3, a relationship graph between the adhesive forces of the PET film and the bonding agents is shown. It can be seen from the drawing that some glues following ful wetting with the substrate can not reach high peel strength; only No. 11 to 13 glues with dissolvability parameter δ approximate to that of the PET film (δ=10.7). The numbers of the bonding agents containing the following components are correspondingly: 1—polyethylene (PE); 2—polyisobutylene; 3—polystyrene, bivinyl; 4—polystyrene; 5—chloroprene rubber (CR); 6—hypalon; 7—acroleic acid, methacrylate ester; 8—polyethylene-vinyl acetate; 9—polyvinyl alcohol (PVA); 10—polyacrylonitrile-bivinyl; 11—ethylene alcohol/TDI; 12—vinyl acetate-bivinyl-maleic anhydride copolymer; 13—bisphenol A/isocyanate; 14—polyvinyl acetate; 15—vinyl chloride-propenyl cyanide copolymer; 16—alkyl/alkoxy nylon.

In addition, the interrelationship of such factors as the size of molecular weight, polarity and crystallinity should be taken into consideration. Taking the above principles as a basis, together with the specific requirements of practical production and a large number of experiments, UV glue is choosen according to this invention as most suitable for bonding this production.

After corona treating, the PET film 1 is coated with glue by printing in screen print manner. The PET film 1 is taken after printing with glue, in which the thickness of the glue should be controlled to range from 6 to 8μ.

After the above steps, the silica gel buttons 2 are placed in the bonding fixture 3, which is preferably made of a bakelite material, since bakelite material dose not generate electrostatic and is less likely to be deformed. The bonding fixture 3 is provided with a plurality of holes 32, into which the silica gel buttons 2 are inserted. The inserting method may be to screen the buttons by shaking the fixture, that is, placing the silica gel buttons 2 onto the bonding fixture 3 and shaking the fixture 3. Alternatively, vacuum-pumping method is used to screen the buttons. Particularly, the bonding fixture 3 is provided with a middle hollow portion (not shown) which is hollow and connected to the holes 32 and a suction hole connected thereto; the air pressure of the middle hollow portion is reduced and thus suction force is generated at the hole 32, then the silica gel buttons 2 are absorbed into the holes 32 of the bonding fixture 3. In this way, most of the silica gel buttons 2 fall into the holes 32, the rest are manually filled. It is possible to perform surface treatment on the silica gel buttons 2 after the placement of the buttons 2 in the bonding fixture 3, such that corona treating is performed on the silica gel buttons 2 together with the bonding fixture 3.

At least two position setting poles 34 are formed on the fixture 3. In this embodiment, four position setting poles 34 are provided. The position setting poles 34 are used to position the PET film 1 coated with glue opposite to the corresponding silica gel buttons 2.

Furthermore, a transparent plate 4 is added to cover the fixture 3, so as to apply a pressure force to exhaust the air inside the glue layer. Four position setting holes 42 are formed in the transparent plate 4, opposite to the position setting poles 34. The transparent plate 4 must use a material with high light throughput which enables the transmission of UV light, such that UV light is able to reach to the glue layer through the transparent plate 4 to solidify the glue.

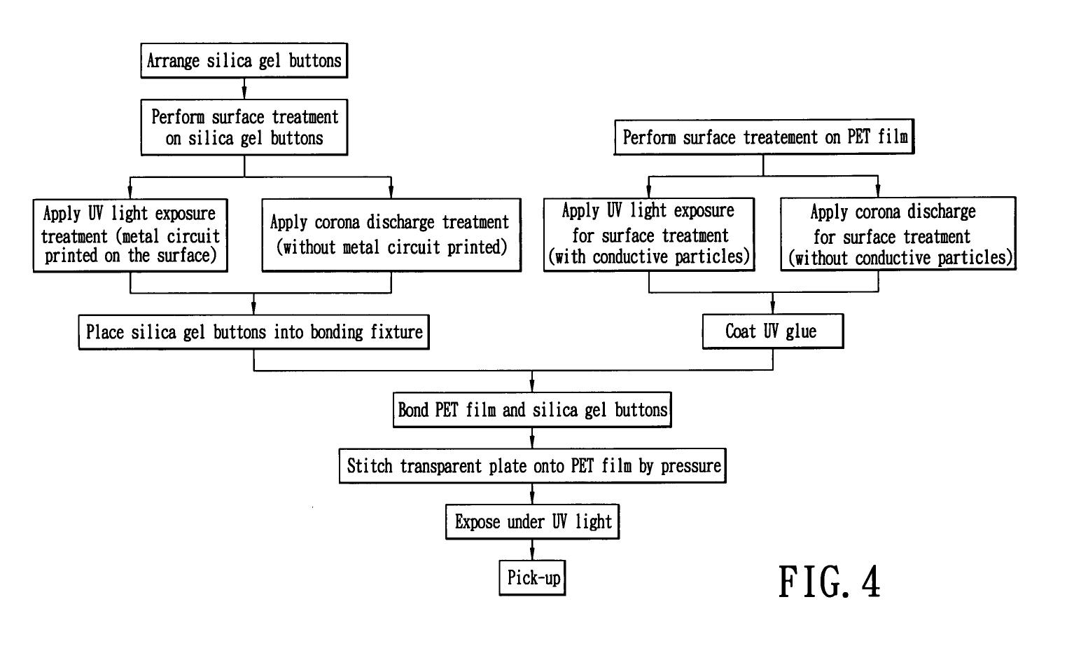

Reference is made to FIG. 4, which is a flow chat illustrating the surface bonding method for the PET film and the silica gel buttons according to this invention, and briefly describing the main steps according to this invention.

In conclusion, the surface bonding method for PET film and silica gel buttons according to this invention can use UV glue to bond the silica gel buttons, resulting in the advantages of high efficiency, a small required number of the fixtures and a simple manufacturing process. With the application of the method according to this invention in the practical production, the objective of saving on costs and improving productivity can be achieved.

According to the surface bonding method of this invention, various steps can be combined in an optimized manner and working with reasonable bonding fixtures to achieve the objectives of low cost, high efficiency and mass production for the products which bond the PET film and silica gel buttons. In the finished manufactured products according to the surface bonding method of this invention, its adhesive force satisfies the requirements of costumers, while product yield and productivity are increased.

The surface bonding method according to the invention uses a special fixture set (including bonding fixture, transparent plate), that simplifies the manufacturing process, saves on costs, and creates a strong bond e thereby making the production of the same types of products competitive.

In conclusion, this invention fully meets the requirements for the patent application. Therefore, the application is proposed according to the patent law. While the preferred embodiments of this invention have been disclosed above, they are not intended to limit the scope of this invention. Therefore the appended claims cover all such changes or modifications as fall within the spirit and scope of this present invention.

What is claimed is:

1. A surface bonding method for PET film and silica gel buttons, comprising the follow steps of:
providing a bonding fixture, which is provided with a plurality of holes and at least two position setting poles;
providing a PET film and performing surface treatment on the PET film;
coating a layer of UV glue on the PET film;
providing a plurality of silica gel buttons;
performing surface treatment on the bottom surfaces of the silica gel buttons;
placing the silica gel buttons into the holes of the bonding fixture;
placing and fixing the PET film to the bonding fixture;
stitching a transparent plate onto the PET film, wherein the transparent plate is provided with position setting holes corresponding to the position setting poles such that the transparent plate is fixed; and
applying the exposure of UV-light on the bonding fixture.

2. The surface bonding method for PET film and silica gel buttons of claim 1, wherein the surface treatment method of corona discharge treating is applied on the PET film without printed metal circuit.

3. The surface bonding method for PET film and silica gel buttons of claim 1, wherein the surface treatment method of UV light exposure is applied on the PET film with printed metal circuit.

4. The surface bonding method for PET film and silica gel buttons of claim 1, wherein the surface treatment method of corona discharge treating is applied on the PET film without conductive particles.

5. The surface bonding method for PET film and silica gel buttons of claim 1, wherein the surface treatment method of UV light exposure is applied on the PET film with conductive particles.

6. The surface bonding method for PET film and silica gel buttons of claim 1, wherein the UV glue is printed in the corresponding position on the PET film by screen print method.

7. The surface bonding method for PET film and silica gel buttons of claim 1, wherein the silica gel buttons are placed into the holes of the bonding fixture by shaking the fixture to screen the silica gel buttons.

8. The surface bonding method for PET film and silica gel buttons of claim 1, wherein the silica gel buttons are placed into the holes of the bonding fixture by using vacuum-pumping to screen the silica gel buttons.

9. The surface bonding method for PET film and silica gel buttons of claim 1, wherein surface treatment is applied to the silica gel buttons after the silica gel buttons are placed into the bonding fixture.

10. The surface bonding method for PET film and silica gel buttons of claim 1, wherein the transparent plate is made of a material through which UV light can transmit.

11. A article of a PET film and silica gel buttons, which is manufactured by applying surface bonding method of claim 1 on the PET film and silica gel buttons, comprising:
a PET film which has a surface treated by surface treatment;
an UV glue, which is coated on the surface of the PET film; and
a plurality of silica gel buttons which are bonded with UV glue to the surface of the PET film by means of a fixture set.

12. The article of PET film and silica gel buttons of claim 11, wherein UV glue forms a layer with the thickness of 6 to 8μ.

13. The article of PET film and silica gel buttons of claim 11, wherein the fixture set comprises a bonding fixture, a transparent plate and at least two of the position setting poles; the bonding fixture is provided with a plurality of holes which can receive the silica gel buttons, and the transparent plate is provided with at least two position setting holes opposite to at least two position setting poles.

14. The article of PET film and silica gel buttons of claim 13, wherein the bonding fixture is made of a bakelite material.

15. The article of PET film and silica gel buttons of claim 13, wherein the bonding fixture is further provided with a middle hollow portion connected to the holes and a suction hole connected to the middle hollow portion.

16. The surface bonding method for PET film and silica gel buttons of claim 13, wherein the transparent plate is made of a material with high light throughout and enabling for UV light transmission.

17. The article of PET film and silica gel buttons of claim 11, wherein the UV glue has a dissolvability parameter approximate to that of the PET film.
